(19) United States
(12) Patent Application Publication
(10) Pub. No.: US 2022/0228281 A1
(43) Pub. Date: Jul. 21, 2022

(54) POROUS METAL BODY AND METHOD FOR PRODUCING POROUS METAL BODY

(71) Applicant: SUMITOMO ELECTRIC TOYAMA CO., LTD., Imizu-shi, Toyama (JP)

(72) Inventors: Hitoshi TSUCHIDA, Imizu-shi (JP); Seiji MABUCHI, Imizu-shi (JP)

(73) Assignee: SUMITOMO ELECTRIC TOYAMA CO., LTD., Imizu-shi, Toyama (JP)

(21) Appl. No.: 17/609,126

(22) PCT Filed: Feb. 10, 2021
(86) PCT No.: PCT/JP2021/005072

§ 371 Date: Nov. 5, 2021

(30) Foreign Application Priority Data
Mar. 27, 2020 (JP) 2020-057177

(51) Int. Cl. C25D 1/08

(52) U.S. Cl. CPC C25D 1/08

(57) ABSTRACT

A porous metal body having a flat plate shape and having a three-dimensional network structure skeleton includes multiple cells, in which, when a ratio of a cell diameter in a thickness direction of the porous metal body to a cell diameter in a direction orthogonal to the thickness direction (cell diameter in thickness direction/cell diameter in direction orthogonal to thickness direction) is defined as a cell diameter ratio, formula (1) and formula (2) below are satisfied:

0.4≥cell diameter ratio≥1.0 formula (1)

0.50<cell diameter in direction orthogonal to thickness direction/(thickness of porous metal body/cell diameter ratio)≥1.50 formula (2)

### TECHNICAL FIELD

The present invention relates to a porous metal body and a method for producing a porous metal body. The present application claims priority to Japanese Patent Application No. 2020-057177 filed Mar. 27, 2020, entire contents of which are herein incorporated by reference.

### BACKGROUND ART

A sheet-shaped porous metal body having a three-dimensional network structure skeleton is used in a variety of applications, such as filters, battery electrode plates, catalyst supports, and metal composite materials, that require heat resistance. For example, Celmet (registered trademark, product of Sumitomo Electric Industries, Ltd.), which is a nickel porous metal body, is widely employed in a variety of industrial fields including electrodes of alkali secondary batteries such as nickel hydrogen batteries, and supports for industrial deodorizing catalysts. Aluminum Celmet (registered trademark, product of Sumitomo Electric Industries, Ltd.), which is an aluminum porous metal body, is stable in organic electrolytes, and thus can be used as a positive electrode of a lithium ion battery.

The aforementioned porous metal bodies can be produced by imparting electrical conductivity to the surface of a three-dimensional network structure skeleton of a porous resin body, then electroplating the surface of the skeleton of the porous resin body to provide a metal plating on the surface, and then removing the porous resin body (for example, see PTL 1 and PTL 2). A preferable example of the porous resin body is a polyurethane resin.

### CITATION LIST

### Patent Literature

PTL 1: Japanese Unexamined Patent Application Publication No. 05-031446

PTL 2: Japanese Unexamined Patent Application Publication No. 2011-225950

### SUMMARY OF INVENTION

According to one aspect of the present disclosure, there is provided a porous metal body having a flat plate shape and having a three-dimensional network structure skeleton, the porous metal body including:

multiple cells,

in which, when a ratio of a cell diameter in a thickness direction of the porous metal body to a cell diameter in a direction orthogonal to the thickness direction (cell diameter in thickness direction/cell diameter in direction orthogonal to thickness direction) is defined as a cell diameter ratio, formula (1) and formula (2) below are satisfied:

0.4≥cell diameter ratio≥1.0 formula (1)

0.50<cell diameter in direction orthogonal to thickness direction/(thickness of porous metal body/cell diameter ratio)≥1.50 formula (2)

### BRIEF DESCRIPTION OF DRAWINGS

FIG. 1 is a schematic diagram illustrating one example of a porous metal body according to the present disclosure.

FIG. 2 is an image of a cross section of one example of a porous metal body according to the present disclosure.

FIG. 3 is a schematic diagram of a structural unit of a three-dimensional network structure of a porous metal body according to the present disclosure.

FIG. 4 is a graph showing the relationship between the porosity (%) and the compressibility (%) of a porous metal body having a three-dimensional network structure skeleton.

FIG. 5 is a schematic diagram showing a step of cutting a porous metal body in a direction orthogonal to the thickness direction in one example of a method for producing a porous metal body according to the present disclosure.

### DESCRIPTION OF EMBODIMENTS

### [Problems to be Solved by Present Disclosure]

When using a polyurethane resin as a porous resin body, first, a polyurethane resin block is worked into a flat plate by peeling or slicing. Next, electrical conductivity is imparted to the surface of the skeleton of the polyurethane resin. When the porous resin body, which has the surface of the skeleton imparted with electrical conductivity, is being plated with a metal, a particular tension is applied to the porous resin body in the plating solution. In order for the porous resin body to maintain a three-dimensional network structure skeleton during peeling or slicing of the polyurethane resin or during the treatment for imparting electrical conductivity, the thickness of the porous resin body needs to be at least twice the cell diameter in a direction orthogonal to the thickness direction. Thus, for example, in order to produce a porous metal body having a thickness of 1.0 mm, it has been necessary to use a porous resin body having a cell diameter of 0.50 mm or less in a direction orthogonal to the thickness direction. In other words, if a porous resin body having a thickness of 1.0 mm or less is used, it has not been possible to produce a porous metal body having a cell diameter larger than 0.50 mm in a direction orthogonal to the thickness direction.

One conceivable method for producing a porous metal body having a thickness of 1.0 mm or less is, for example, a method that involves preparing a porous metal body having a thickness greater than 1.0 mm and then rolling this porous metal body to reduce the thickness to 1.0 mm or less. However, in a porous metal body having a thickness reduced to 1.0 mm by rolling, cells are squashed in the thickness direction, and the porosity decreases as a result. Thus, a porous metal body having a thickness reduced to 1.0 mm by rolling has faced an issue of increased pressure loss when used as, for example, a filter.

Thus, an object of the present disclosure is to provide a flat plate-shaped porous metal body having a thickness less than twice the cell diameter in a direction orthogonal to the thickness direction.

### [Description of Embodiments of Present Disclosure]

First, the embodiments of the present disclosure are listed and described.

[1] One embodiment of the present disclosure provides

a porous metal body having a flat plate shape and having a three-dimensional network structure skeleton, the porous metal body including:

multiple cells,

in which, when a ratio of a cell diameter in a thickness direction of the porous metal body to a cell diameter in a direction orthogonal to the thickness direction (cell diameter in thickness direction/cell diameter in direction orthogonal to thickness direction) is defined as a cell diameter ratio, formula (1) and formula (2) below are satisfied:

0.4≥cell diameter ratio≥1.0 formula (1)

0.50<cell diameter in direction orthogonal to thickness direction/(thickness of porous metal body/cell diameter ratio)≥1.50 formula (2)

According to this embodiment, a flat plate-shaped porous metal body having a thickness less than twice the cell diameter in a direction orthogonal to the thickness direction can be provided.

[2] The cell diameter in the direction orthogonal to the thickness direction of the porous metal body may be greater than 0.4 mm and 1.70 mm or less.

According to this embodiment, even when the cell diameter in a direction orthogonal to the thickness direction is greater than 0.4 mm, a porous metal body having a thickness of 0.8 mm or less can be provided.

[3] The porous metal body may have a thickness of 0.5 mm or more and 1.2 mm or less.

According to this embodiment, even when the thickness is as small as 1.2 mm or less, a porous metal body having a cell diameter greater than 0.6 mm in a direction orthogonal to the thickness direction can be provided.

[4] The porous metal body may have a porosity of 94% or more and 99% or less.

According to this embodiment, a porous metal body having a high porosity can be provided.

[5] The porous metal body may have a coating weight of 100 g/m² or more and 250 g/m² or less.

According to this embodiment, a very light porous metal body can be provided.

Note that the coating weight refers to the weight of a porous metal body relative to an area calculated from the external dimensions of the porous metal body as viewed in plan.

[6] Another embodiment of the present disclosure provides

a method for producing the porous metal body described in [1] above, the method including:

a step of imparting electrical conductivity to a surface of a skeleton of a porous resin body having a flat plate shape, the skeleton being a three-dimensional network structure skeleton;

a next step of plating the surface of the skeleton of the porous resin body with a metal;

a next step of removing the porous resin body to obtain a thick plate-shaped porous metal body; and

a next step of cutting the thick plate-shaped porous metal body in a direction orthogonal to a thickness direction to obtain a porous metal body.

According to this embodiment, a method for producing a flat plate-shaped porous metal body having a thickness less than twice the cell diameter in a direction orthogonal to the thickness direction can be provided.

[7] The method for producing the porous metal body may further include a step of compressing, in the thickness direction, the porous metal body which has been cut in the direction orthogonal to the thickness direction.

According to this embodiment, a method for producing a porous metal body that can more stably maintain the flat plate shape can be provided.

### [Detailed Description of Embodiments of Present Disclosure]

Hereinafter, specific examples of the porous metal body and the method for producing a porous metal body according to embodiments of the present disclosure are described in further detail. Note that the present disclosure is not limited by these examples but is defined by the claims that are intended include all modifications and alterations within the scope and meaning of the equivalents of the claims.

### <Porous Metal Body>

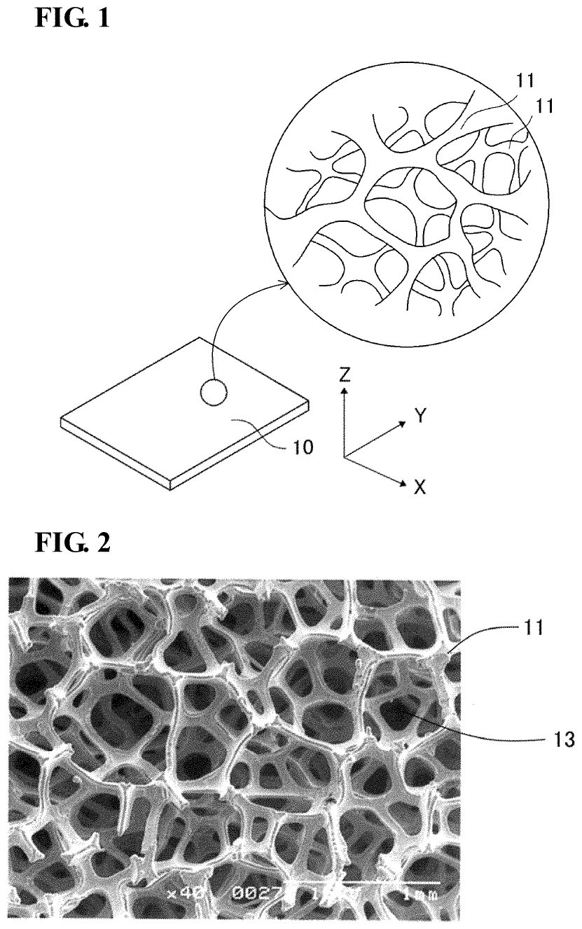

Hereinafter, referring to FIGS. 1 to 3, individual features of a porous metal body 10 according to one embodiment of the present disclosure are described.

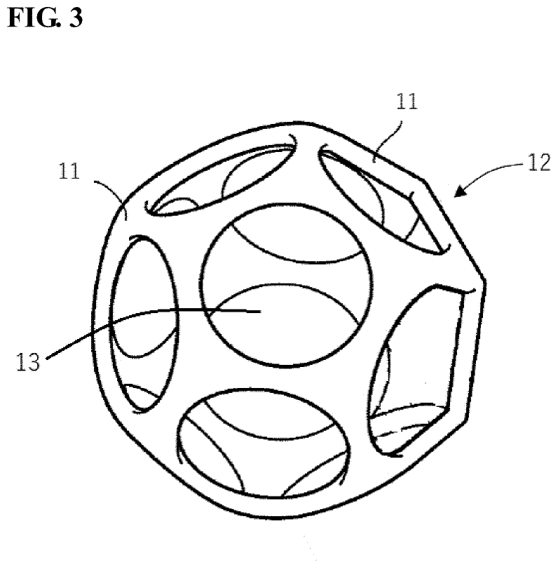

The porous metal body 10 has a three-dimensional network structure skeleton 11. The porous metal body 10 as a whole has an appearance of a flat plate. FIG. 3 illustrates a regular dodecahedron simulating a structural unit of the three-dimensional network structure to facilitate understanding of the three-dimensional network structure. The structural unit of the three-dimensional network structure includes one cell 12. As illustrated in FIGS. 2 and 3, the cell 12 includes a pore 13, which is a three-dimensional space formed by the three-dimensional network structure skeleton 11. When the three-dimensional network structure structural unit is resembled as a regular dodecahedron, the cell diameter is defined by the longest diagonal line of the regular dodecahedron.

The skeleton 11 is typically composed of a metal or alloy film, and the interior of the skeleton 11 is void.

Examples of the metal constituting the skeleton 11 include nickel, aluminum, and copper. Examples of the alloy constituting the skeleton 11 include alloys of aforementioned metals formed by intentional or unavoidable addition of other metals. Examples of the alloy constituting the skeleton 11 include nickel alloyed with chromium, cobalt, and tin (NiCr, NiCo, NiSn etc.). Moreover, the skeleton 11 may have a multilayer structure having two or more layers of metal or alloy films obtained by further plating the surface of the aforementioned metal or the alloy with yet another metal.

As mentioned above, the porous metal body 10 includes the pore 13, which is a three-dimensional space, and has a three-dimensional network structure. Thus, the porous metal body 10 can be clearly distinguished from a two-dimensional network structure (for example, a punched metal and a mesh) that has only flat holes.

Furthermore, as illustrated in FIGS. 1 to 3, the porous metal body 10 has a three-dimensional network structure skeleton 11 and thus can be clearly distinguished from structures, such as nonwoven cloths, formed by entangling fibers.

Since the porous metal body 10 has such a three-dimensional network structure, the porous metal body 10 has multiple pores that are connected from the surface to the interior.

The cell diameter in a direction (any desired direction on a plane parallel to the X-Y plane in FIG. 1) orthogonal to the thickness direction (the Z axis direction in FIG. 1) of the porous metal body 10 is determined by observing the main surface of the porous metal body 10 with a microscope or the like for at least ten viewing areas, determining the average number (nc) of cells 12 per inch (25.4 mm=25,400 μm), and calculating the cell diameter from formula (3) below:

cell diameter in direction orthogonal to thickness direction=25,400 μm/nc formula (3)

The cell number is determined by a method for determining the cell number in flexible cellular polymeric materials in accordance with JIS K 6400-1:2004, Annex 1 (reference) (excluding the provisions regarding the dimensions of the test piece).

The cell diameter in the thickness direction of the porous metal body 10 is either calculated by formula (4) below or by actually measuring the cell diameter at a cross section taken in the thickness direction of the porous metal body 10.

cell diameter in thickness direction=cell diameter in direction orthogonal to thickness direction×(1−compressibility/100) formula (4)

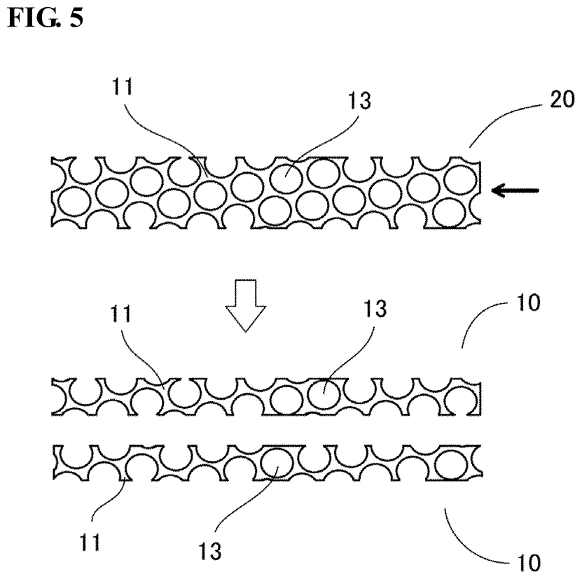

The compressibility (%) in formula (4) can be determined from the graph illustrating the relationship between the porosity and the compressibility in FIG. 5. In FIG. 5, the vertical axis indicates the porosity (%) of the porous metal body and the horizontal axis indicates the compressibility (%) of the porous metal body.

When the cell diameter is to be actually measured at a cross section taken in the thickness direction of the porous metal body 10, the cell diameter in the thickness direction is calculated as follows.

First, the porous metal body 10 is embedded in a resin and cut in the thickness direction, followed by observation of the resulting cross section. Next, in this cross section, ten circles of arbitrarily selected cells 12 are drawn, and the average of the cell diameters thereof is calculated.

The porosity of the porous metal body 10 is defined by following formula (5) below:

porosity (%)=[1−{Mp/(Vp×dp)}]×100 formula (5)
Mp: mass of porous metal body [g]
Vp: volume of shape of external appearance of porous metal body [cm³]
dp: density of metal constituting porous metal body [g/cm³]

The thickness of the porous metal body 10 can be measured with, for example, a digital thickness gauge.

In formula (1), the cell diameter ratio indicates how much the porous metal body 10 is compressed in the thickness direction after the production thereof. The cell diameter ratio is to be 0.4 or more and 1.0 or less, is preferably 0.5 or more and 1.0 or less, and is more preferably 0.7 or more and 1.0 or less.

A regular dodecahedron can be used as the model of the shape of the cell 12; thus, when the porous metal body 10 is not compressed in the thickness direction by rolling or the like, there is no difference between the cell diameter in the thickness direction and the cell diameter in a direction orthogonal to the thickness direction. Thus, a cell diameter ratio of 1.0 indicates that the porous metal body 10 is not compressed in the thickness direction after the production thereof. Thus, for example, when the porous metal body 10 is used as a filter, the cell diameter ratio is preferably close to 1.0 from the viewpoint of decreasing the pressure loss. It should be noted that a cell diameter ratio of 0.4 indicates that the compressibility of the porous metal body 10 in the thickness direction is 60%.

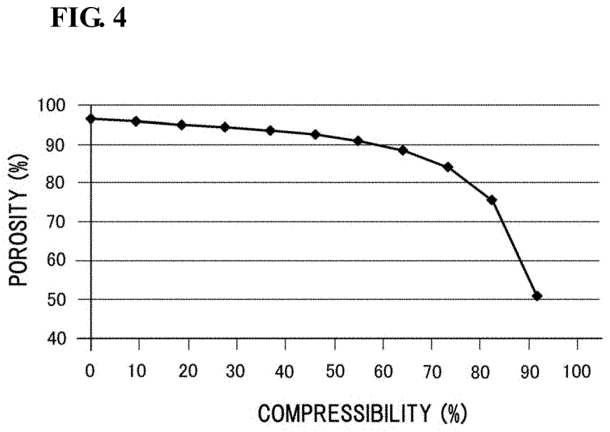

Although the compressibility of the porous metal body 10 can be determined from the graph shown in FIG. 4 as mentioned above, the compressibility can be calculated from compressibility (%)=(1−(thickness of porous metal body after compression/thickness of porous metal body before compression))×100 if the thicknesses of the porous metal body 10 before and after compression are known.

In formula (2), “(thickness of porous metal body/cell diameter ratio)” indicates the thickness of the porous metal body 10 before compression in the thickness direction. This is because, since the cell diameter ratio indicates how much the porous metal body 10 is compressed in the thickness direction as described above, the thickness of the porous metal body 10 before the compression is calculated by dividing the thickness of the porous metal body 10 after the compression by the cell diameter ratio.

The cell diameter in a direction orthogonal to the thickness direction of the porous metal body 10 may be appropriately selected according to the usage of the porous metal body 10. For example, the cell diameter in a direction orthogonal to the thickness direction is preferably greater than 0.40 mm and 1.70 mm or less, more preferably 0.5 mm or more and 1.1 mm or less, and yet more preferably 1.0 mm or less.

Even when the cell diameter in a direction orthogonal to the thickness direction exceeds 0.40 mm, the thickness of the porous metal body 10 can be decreased to 1.0 mm or less or even 0.5 mm or less. Thus, for example, when the porous metal body 10 is used as a filter, the thickness can be decreased without excessively decreasing the mesh size, and thus the pressure loss can be reduced. Moreover, when the porous metal body 10 is used as an electrode of a battery, the active material filling property can be improved, and when the porous metal body 10 is used as an electrode of a hydrogen generator, gas generated from the electrode can be smoothly released.

The thickness of the porous metal body 10 may be appropriately selected according to the usage of the porous metal body 10. For example, the thickness of the porous metal body 10 is preferably 0.5 mm or more and 1.2 mm or less.

Even when the thickness of the porous metal body 10 is 1.2 mm or less, the cell diameter in a direction orthogonal to the thickness direction can be greater than 0.6 mm.

As long as the porous metal body 10 is not compressed in the thickness direction, the porous metal body 10 has a porosity determined by subtracting the volume of the porous resin body used as a base material during the production. The porosity of the porous metal body 10 changes depending on the compressibility as illustrated in the graph in FIG. 4. For example, even when the porous metal body 10 is rolled at a compressibility of about 60%, the porosity of the porous metal body 10 remains to be higher than 90%.

The porosity of the porous metal body 10 may be appropriately selected according to the usage of the porous metal body 10. For example, the porosity of the porous metal body 10 is preferably 94% or more and 99% or less, more preferably 96% or more and 99% or less, and yet more preferably 97% or more and 99% or less.

The coating weight of the porous metal body 10 may be appropriately selected according to the usage of the porous metal body 10. When a very light porous metal body is required, the coating weight of the porous metal body 10 is preferably 100 g/m² or more and 250 g/m² or less, for example. Since the porous metal body 10 is obtained by cutting, in a direction orthogonal to the thickness direction, a porous metal body produced by a plating method, the coating weight is 1/2 or less of the coating weight of the porous metal body before cutting. Thus, the porous metal body 10 can be easily provided as a very light product. It is needless to say that the coating weight may be high depending on the usage of the porous metal body.

### <Method for Producing Porous Metal Body>

A method for producing a porous metal body according to one embodiment of the present disclosure includes a step of imparting electrical conductivity to a surface of a skeleton of a porous resin body having a flat plate shape, the skeleton being a three-dimensional network structure skeleton; a step of plating the surface of the skeleton of the porous resin body with a metal; a step of removing the porous resin body to obtain a porous metal body; and a step of cutting the porous metal body, which is obtained by removing the porous resin body, in a direction orthogonal to a thickness direction.

The individual steps are described in detail below.

### (Step of Imparting Electrical Conductivity to the Surface of the Skeleton of the Porous Resin Body)

In this step, first, a flat plate-shaped porous resin body (hereinafter simply referred to as the “porous resin body”) having a three-dimensional network structure skeleton is prepared. A polyurethane resin, a melamine resin, or the like can be used as the porous resin body.

The porous resin body is used as a base material for producing a porous metal body. Thus, the cell diameter in a direction orthogonal to the thickness direction, the porosity, and the thickness of the porous resin body may be set to be the same as those of the porous metal body intended to be produced.

Subsequently, a coating material containing conductive powder such as carbon powder is applied to the surface of the porous resin body skeleton to impart electrical conductivity to the surface of the skeleton of the porous resin body. Examples of the carbon powder include amorphous carbon powder such as carbon black, and carbon powder such as graphite.

(Step of Plating with Metal)

In this step, the porous resin body having the skeleton surface imparted with electrical conductivity is used as a base material and plated with a metal. Since the surface of the skeleton of the porous resin body is imparted with electrical conductivity, electroplating is preferably employed for metal plating.

The type of the metal plated on the porous resin body is not particularly limited. The type of the metal may be appropriately selected according to the usage of the porous metal body. For example, in the case of a metal such as nickel, aluminum, or copper, electroplating may be performed by a known plating method. Two or more metals may be alloyed through plating. For example, after plating with nickel, plating with chromium, cobalt, tin, or the like may be performed to be alloyed with nickel. By plating with two or more metals, the skeleton 11 of the porous metal body 10 can have a multilayer structure having two or more metal or alloy films.

The metal plating amount is not particularly limited, and may be adjusted so that the porous metal body 10 to be produced would have a preferable coating weight. The porous metal body 10 is obtained by cutting, in a direction orthogonal to the thickness direction, a porous metal body obtained by removing the porous resin body plated with the metal. Thus, in the step of plating with a metal, the metal plating amount may be adjusted by considering that the coating weight of the porous metal body 10 is ½ or less of the coating weight of the porous metal body before cutting.

### (Step of Removing the Porous Resin Body)

This step involves removing the porous resin body used as the base material from the structure obtained by forming a metal or alloy film on the surface of a skeleton. The porous resin body can be removed in, for example, an oxidizing atmosphere, such as atmospheric air, by a heat treatment at a temperature of about 600° C. or higher and 800° C. or lower and preferably at a temperature of about 600° C. or higher and 700° C. or lower. In this manner, the porous resin body used as the base material is burned and removed, and a porous metal body having a skeleton formed of the metal or alloy film is obtained. After removal of the porous resin body, the oxidized metal or alloy may be reduced by a heat treatment in a reducing atmosphere, if needed.

### (Step of Cutting the Porous Metal Body)

As illustrated in FIG. 5, this step involves cutting, in a direction orthogonal to the thickness direction (the Z axis direction in FIG. 1), a thick plate-shaped porous metal body 20 obtained by removing the porous resin body so as to obtain porous metal bodies 10 of this embodiment. As described above, a porous resin body used as the base material cannot maintain the three-dimensional network structure skeleton and will collapse unless the thickness thereof is at least twice the cell diameter in a direction orthogonal to the thickness direction. In addressing this issue, the present inventors have found that, since the strength of the skeleton increases as a result of plating with a metal, it is possible to cut a porous metal body to a thickness less than twice the cell diameter in a direction orthogonal to the thickness direction. In this step, the thick plate-shaped porous metal body 20 may be cut so that porous metal bodies 10 that satisfy formula (2) are obtained.

The method for cutting the thick plate-shaped porous metal body 20 is not particularly limited, and, for example, the thick plate-shaped porous metal body 20 may be fixed with jigs at the main surfaces thereof, and then the portion between the main surfaces may be cut with a rotating blade or the like. Although the thick plate-shaped porous metal body 20 is cut into two pieces in a direction orthogonal to the thickness direction Z in the example illustrated in FIG. 5, the thick plate-shaped porous metal body 20 may be cut into three or more pieces. For example, a thick plate-shaped porous metal body 20 produced by using a porous resin body having a thickness of about 2.0 mm can be cut into three pieces to obtain three porous metal bodies 10 each having a thickness of about 0.66 mm.

### (Step of Compressing the Porous Metal Body)

This step involves compressing, in the thickness direction, the porous metal body 10 which has been cut in a direction orthogonal to the thickness direction. The porous metal body 10 can be given a desired thickness by compressing the porous metal body 10 in the thickness direction, and, furthermore, the flat plate shape can be more stably maintained, thereby improving the handling properties. Compressing the porous metal body 10 in the thickness direction squashes the cell 12 and decreases the porosity. Thus, the porous metal body 10 may be compressed within the range that satisfies formula (1) into a desired thickness and a desired porosity according to the usage of the porous metal body 10.

### EXAMPLES

The present disclosure will now be described in further detail through examples. These examples are merely illustrative, and do not limit the porous metal body and the like of the present disclosure.

### Example 1

A polyurethane sheet having a thickness of 2.0 mm was prepared as a porous resin body having a three-dimensional network structure skeleton. The porous resin body had a porosity of 96%. The cell diameter in a direction orthogonal to the thickness direction was 0.85 mm.

Electrical conductivity was imparted to the surface of the skeleton of the polyurethane sheet by immersing the polyurethane sheet in a carbon suspension and drying the resulting sheet. The carbon suspension component contained 25% of graphite and carbon black, a resin binder, a penetrant, and an antifoam. Carbon black had a particle diameter of 0.5 μm.

The surface of the skeleton of the polyurethane sheet imparted with electrical conductivity was plated with a nickel at a coating weight of 500 g/m². Nickel plating was conducted by using a Watts bath (nickel sulfate: 300 g/L, nickel chloride: 50 g/L, boric acid: 30 g/L).

After nickel plating, heating was performed at 650° C. for 10 minutes to burn and remove the polyurethane sheet used as the base material. After removal of the polyurethane sheet, a heat treatment was further performed at 1000° C. for 20 minutes in a H₂:N₂=3:1 atmosphere to reduce the oxidized nickel.

The porous metal body after the reducing treatment was cut into two pieces in a direction orthogonal to the thickness direction Z as illustrated in FIG. 5. As a result, two porous metal bodies No. 1 each having a thickness of 1.0 mm were obtained.

### Example 2

A porous metal body No. 1 produced in Example 1 was compressed in the thickness direction to a thickness of 0.5 mm so as to prepare a porous metal body No. 2.

### Example 3

A polyurethane sheet having a thickness of 3.0 mm, a cell diameter of 0.85 mm in a direction orthogonal to the thickness direction, and a porosity of 96% was used, and a porous metal body after the reducing treatment was cut into three pieces in a direction orthogonal to the thickness direction Z. Three porous metal bodies No. 3 were produced under the same conditions as those in Example 1 except for these conditions.

### Example 4

A porous metal body No. 3 produced in Example 3 was compressed in the thickness direction to a thickness of 0.5 mm so as to prepare a porous metal body No. 4.

### Example 5

A polyurethane sheet having a thickness of 2.0 mm, a cell diameter of 0.54 mm in a direction orthogonal to the thickness direction, and a porosity of 96% was used. Then porous metal bodies No. 5 each having a thickness of 1.0 mm were prepared under the same conditions as those in Example 1 except for this condition.

### Example 6

A porous metal body No. 5 produced in Example 5 was compressed in the thickness direction to a thickness of 0.5 mm so as to prepare a porous metal body No. 6.

### Example 7

A polyurethane sheet having a thickness of 2.5 mm, a cell diameter of 1.27 mm in a direction orthogonal to the thickness direction, and a porosity of 96% was used. Then porous metal bodies each having a thickness of about 1.2 mm were prepared under the same conditions as those in Example 1 except for this condition, and were rolled to a thickness of 1.0 mm so as to prepare porous metal bodies No. 7.

### Example 8

A porous metal body No. 7 produced in Example 7 was compressed in the thickness direction to a thickness of 0.5 mm so as to prepare a porous metal body No. 8.

### Comparative Example 1

In the production method described in Example 1, the porous metal body after the reducing treatment was not cut but was compressed to a thickness of 0.5 mm. A porous metal body No. 9 was produced under the same conditions as those in Example 1 except for this condition.

### Comparative Example 2

In Example 7, the porous metal body after the reducing treatment was cut into three pieces in a direction orthogonal to the thickness direction Z. Three porous metal bodies No. 10 were produced under the same conditions as those in Example 7 except for this condition. The thickness of each of the porous metal bodies No. 10 was supposed to be about 0.8 mm. However, since the porous metal bodies No. 10 were outside the numerical range of formula (2), it was difficult to maintain the three-dimensional network structure skeletons, and, during the cutting step operation or after the operation, the skeletons broke upon even small impact, and most of the three-dimensional network structures had collapsed. Table 1 indicates various figures of the porous metal bodies that were supposed to be obtained after the cutting step.

### Comparative Example 3

An attempt was made to prepare a polyurethane sheet having a thickness of 1.0 mm, a cell diameter of 0.54 mm in a direction orthogonal to the thickness direction, and a porosity of 96%. However, the polyurethane sheet could not maintain the three-dimensional network structure skeleton, and most of the three-dimensional network structure had collapsed.

The measured values and calculated values for the structures of porous metal bodies No. 1 to No. 10 are indicated in Table 1.

TABLE 1

| | Cell diameter | | | | | | | |
|---|---|---|---|---|---|---|---|---|
| | in direction | | | | | | Cell diameter in direction | |
| Porous | orthogonal | Cell diameter | | Coating | | Cell | orthogonal to thickness | Thickness of |
| metal | to thickness | in thickness | Thickness | weight | Porosity | diameter | direction/(thickness of porous | porous resin |
| body No. | direction (mm) | direction (mm) | (mm) | (g/m²) | (%) | ratio | metal body/cell diameter ratio) | body (mm) |
| 1 | 0.85 | 0.85 | 1.00 | 250 | 97 | 1.00 | 0.85 | 2.0 |
| 2 | 0.85 | 0.43 | 0.50 | 250 | 94 | 0.50 | 0.85 | 2.0 |
| 3 | 0.85 | 0.85 | 1.00 | 166 | 98 | 1.00 | 0.85 | 3.0 |
| 4 | 0.85 | 0.43 | 0.50 | 166 | 96 | 0.50 | 0.85 | 3.0 |
| 5 | 0.54 | 0.54 | 1.00 | 250 | 97 | 1.00 | 0.54 | 2.0 |
| 6 | 0.54 | 0.27 | 0 50 | 250 | 94 | 0.50 | 0.54 | 2.0 |
| 7 | 1.27 | 1.02 | 1.00 | 250 | 97 | 0.80 | 1.02 | 2.5 |
| 8 | 1.27 | 0.51 | 0.50 | 250 | 94 | 0.40 | 1.02 | 2.5 |
| 9 | 0.85 | 0.21 | 0.50 | 500 | 89 | 0.25 | 0.43 | 2.0 |
| 10 | 1.27 | 1.27 | 0.83 | 166 | 98 | 1.00 | 1.53 | 2.5 |

As indicated in Table 1, in all of the porous metal bodies No. 1 to No. 8, the “cell diameter in direction orthogonal to thickness direction/(thickness of porous metal body/cell diameter ratio)” was greater than 0.5, and the thickness was less than twice the cell diameter in a direction orthogonal to the thickness direction. Thus, a high porosity could be maintained even when the thickness was about 0.5 mm. In addition, a porous metal body having a cell diameter of 0.50 mm or more in the thickness direction could be produced even when the thickness was 1.0 mm or less. A porous metal body having a high porosity and a large cell diameter is, for example, suitable for use in a low-pressure-loss filter.

With the porous metal body according to an embodiment of the present disclosure, it becomes possible to select a cell diameter, a porosity, a thickness, and a coating weight that are more preferable for the usage of the porous metal body.

### REFERENCE SIGNS LIST

10 porous metal body

11 skeleton

12 cell

13 pore

20 thick plate-shaped porous metal body

1. A porous metal body having a flat plate shape and having a three-dimensional network structure skeleton, the porous metal body comprising:
a plurality of cells,
wherein, when a ratio of a cell diameter in a thickness direction of the porous metal body to a cell diameter in a direction orthogonal to the thickness direction (cell diameter in thickness direction/cell diameter in direction orthogonal to thickness direction) is defined as a cell diameter ratio, formula (1) and formula (2) below are satisfied:
0.4≥cell diameter ratio≥1.0 formula (1)
0.50<cell diameter in direction orthogonal to thickness direction/(thickness of porous metal body/cell diameter ratio)≥1.50 formula (2)

2. The porous metal body according to claim 1, wherein the cell diameter in the direction orthogonal to the thickness direction of the porous metal body is greater than 0.4 mm and 1.70 mm or less.

3. The porous metal body according to claim 1,
wherein the porous metal body has a thickness of 0.5 mm or more and 1.2 mm or less.

4. The porous metal body according to claim 1,
wherein the porous metal body has a porosity of 94% or more and 99% or less.

5. The porous metal body according to claim 1,
wherein the porous metal body has a coating weight of 100 g/m² or more and 250 g/m² or less.

6. A method for producing the porous metal body according to claim 1, the method comprising:
a step of imparting electrical conductivity to a surface of a skeleton of a porous resin body having a flat plate shape, the skeleton being a three-dimensional network structure skeleton;
a next step of plating the surface of the skeleton of the porous resin body with a metal;
a next step of removing the porous resin body to obtain a thick plate-shaped porous metal body; and
a next step of cutting the thick plate-shaped porous metal body in a direction orthogonal to a thickness direction to obtain a porous metal body.

7. The method for producing the porous metal body according to claim 6,
further comprising a step of compressing, in the thickness direction, the porous metal body which has been cut in the direction orthogonal to the thickness direction.
